(19) United States
(12) Patent Application Publication
(10) Pub. No.: US 2020/0103101 A1
(43) Pub. Date: Apr. 2, 2020

(54) PIGTAIL HANGER

(71) Applicant: Lee Valley Tools Ltd., Ottawa (CA)

(72) Inventors: Steven K. Jones, Nepean (CA); Robin C. Lee, Ottawa (CA)

(21) Appl. No.: 16/146,739

(22) Filed: Sep. 28, 2018

(51) Int. Cl. F21V 21/08; F21S 4/10

(52) U.S. Cl. CPC F21V 21/08; F21W 2121/004; F21S 4/10

(57) ABSTRACT

A pigtail hanger for hanging a cable, e.g. Christmas tree lights, or for hanging from a cable, e.g. cloths line, comprises helical hanger including a plurality of turns around a longitudinal axis for receiving a cable extending therethrough; and a mounting bracket extending substantially perpendicular to the longitudinal axis of the helical hanger for mounting on a surface or for supporting a load.

### TECHNICAL FIELD

The present invention relates to a hanging support, and in particular to a pigtail hanger for hanging an elongated cord, such as a strand of Christmas tree lights, or for hanging from an elongated cord, such as a clothes line.

### BACKGROUND

Conventional hooks for hanging Christmas tree lights include some form of spring biased clip with a hook extending therefrom. Unfortunately, in an effort to make the hangers affordable, the clips are often constructed of inexpensive material that breaks after limited usage. Moreover, conventional clips typically fix the hanger in position, making adjustments difficult or cause damage to the clips.

An object of the present invention is to overcome the shortcomings of the prior art by providing a pigtail hanger including a spiral holder for securely but adjustably mounting the hanger to the cord, and a mounting bracket for hanging the cord or for hanging something from the cord.

### SUMMARY OF THE INVENTION

Accordingly, the present invention relates to a pigtail hanger comprising:

a helical hanger including a plurality of turns around an longitudinal axis for receiving a cable or conduit extending therethrough; and

a mounting bracket extending substantially perpendicular to the longitudinal axis of the helical hanger for supporting a load.

### BRIEF DESCRIPTION OF THE DRAWINGS

The invention will be described in greater detail with reference to the accompanying drawings which represent preferred embodiments thereof, wherein:

FIG. 1 is an isometric view in accordance with an embodiment of the present invention;

FIG. 2 is a side view of the device of FIG. 1;

FIG. 3 is an end view of the device of FIG. 1;

FIG. 4 is a top view of the device of FIG. 1;

FIG. 5a is an isometric view of another embodiment of the present invention;

FIG. 5b is a side view of the embodiment of FIG. 5a;

FIG. 5c is an end view of the embodiment of FIG. 5a;

FIG. 6 is a top view of the embodiment of FIG. 5a

FIG. 7a is an isometric view of another embodiment of the present invention;

FIG. 7b is a side view of the embodiment of FIG. 7a;

FIG. 7c is an end view of the embodiment of FIG. 7a;

FIG. 8 is an isometric view in accordance with another embodiment of the present invention;

FIG. 9 is an end view of the embodiment of FIG. 8;

FIG. 10 is a side view of the embodiment of FIG. 8;

FIG. 11 is a top view of the embodiment of FIG. 8;

FIG. 12 is a side view in accordance with another embodiment of the present invention;

FIG. 13 is an end view of the embodiment of FIG. 12;

FIG. 14 is a top view of the embodiment of FIG. 12;

FIG. 15 is an isometric view in accordance with another embodiment of the present invention;

FIG. 16 is a side view of the embodiment of FIGS. 15; and

FIG. 17 is an end view of the embodiment of FIG. 15.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

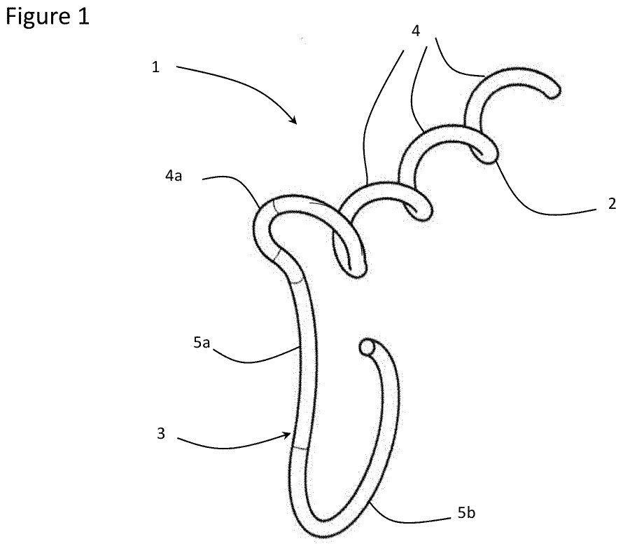

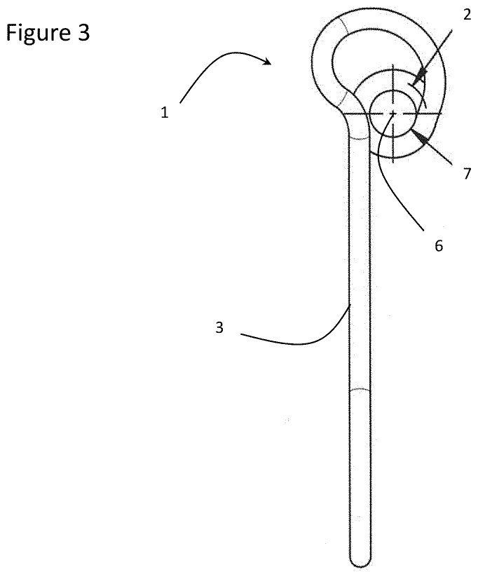

With reference to FIGS. 1 to 4, an embodiment of a pigtail hook 1 of the present invention includes a helical hanger 2 and a mounting bracket 3. The helical hanger 2 may comprise a cylindrical helix with three or more turns, preferably three to five turns 4 wound around a longitudinal axis 6, and defining a cylindrical cavity 7 with a constant radius, which may be from 0.2″ to 2″. For example the cylindrical cavity 7 may comprise a radius of 0.1″ to 0.4″ for receiving a cord (not shown), such as a Christmas tree light cord or a clothes line cable. Alternatively, the cylindrical cavity 7 may comprise a radius of 0.4″ to 2″ for receiving and supporting or being supported by a larger flexible cord or conduit, e.g. a hose. The turns 4 may have a pitch of 1.0″ to 1.5″, and may extend at an angle of 55° to 70° to the longitudinal axis 6. The extra number of turns, e.g. >3, provides a stable attachment to the cord by distributing the force of the load over a longer distance and making it more difficult to unwind the cord from the helical hanger 2, preventing accidental release. The helical hanger 2 may range from 2″ to 6″ long depending upon the desired use, e.g. load requirement. The helical hanger 2 also facilitates lateral adjustment of the pigtail hanger 1 relative to the cord by enabling an unopposed simple sliding motion along the cord.

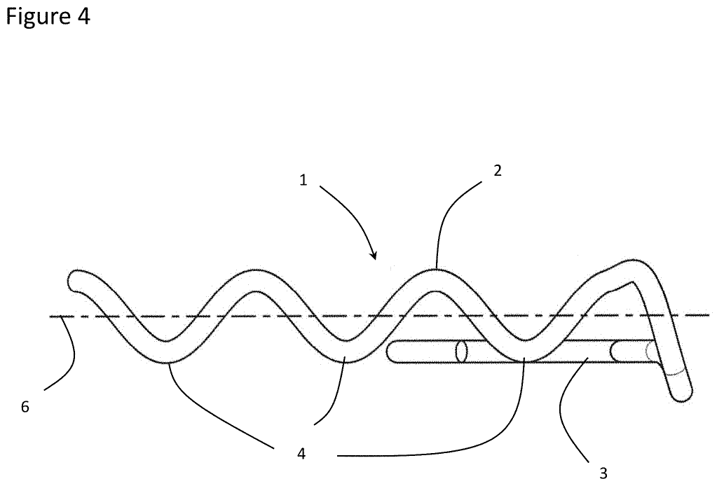

The mounting bracket 3 may be comprised of an elongated arm 5a and a hook 5b, with a central axis 8, and a radius 9, which may be any suitable length depending on the desired use, e.g. 0.5-1.0 inches. In the illustrated embodiment, the hook 5b extends in substantially the same direction as the helical hanger 2, i.e. the central axis 8 of the hook 3 is substantially perpendicular to the longitudinal axis 6 of the spiral hanger 2, although a slight angle, e.g. 1° to 10°, between the hook 3 and the longitudinal axis 6 may be provided depending upon the desired usage. With reference to FIG. 4, the mounting bracket 3 may extend offset, and parallel to the longitudinal axis 6 of the spiral hanger 2, enabling the cord, extending through the spiral hanger 2, to be slightly offset from the top of the hook 3 and therefore any surface or structure that the hook 5b is mounted on or connected to.

To facilitate mounting and dismounting of the helical hanger 2 onto and off of a cable, the last turn 4a of the helical hanger 2 may extend upwardly and outwardly from the previous turn forming a partial turn with a much larger radius than the previous turns 4, e.g. 1.5× to 3×.

Ideally, the entire pigtail hanger 1 may be comprised of a single length of resilient metallic, corrosion resistant, e.g. stainless steel or plastic coated, wire with a diameter of 0.05″ to 0.25″.

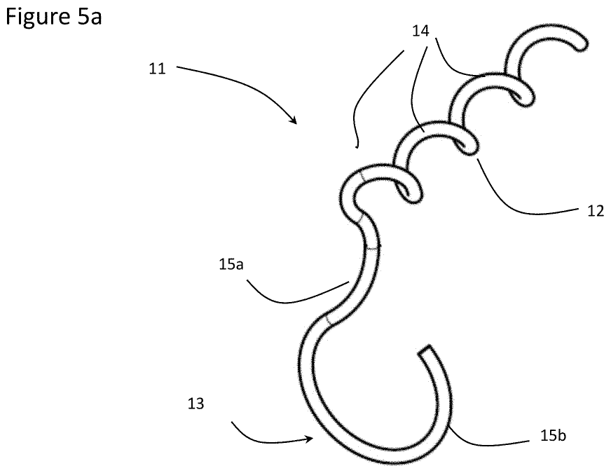

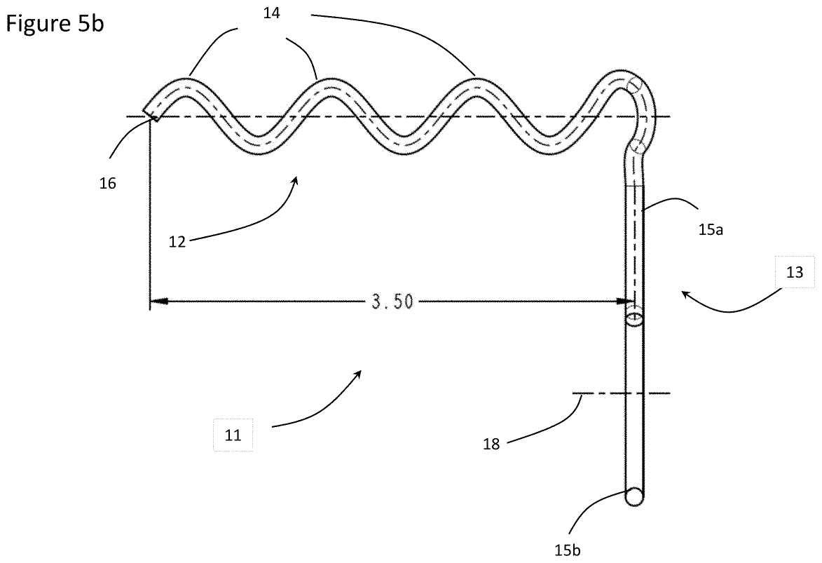

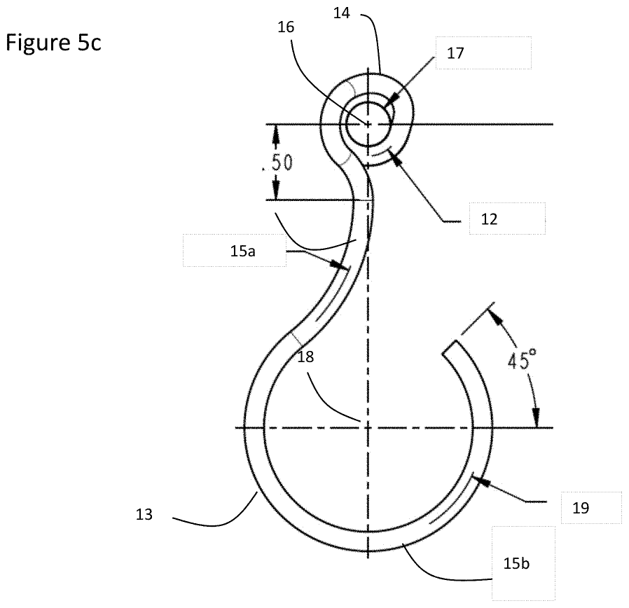

With reference to FIGS. 5a to 7c, another embodiment of a pigtail hanger 11 of the present invention includes a helical hanger 12 and a mounting bracket 13. The helical hanger 12 may comprise a cylindrical helix with three or more turns, preferably three to five turns 14 wound around a longitudinal axis 16, and defining a cylindrical cavity 17 with a substantially constant radius, which may be from 0.2″ to 2″. For example the cylindrical cavity 17 may comprise a radius of 0.1″ to 0.4″ for receiving a cord (not shown), such as a Christmas tree light cord or a clothes line cable. Alternatively, the cylindrical cavity 17 may comprise a radius of 0.4″ to 2″ for receiving and supporting or being supported by a larger flexible cord or conduit, e.g. a hose. The turns 14 may have a pitch of 1.0″ to 1.5″, and may extend at an angle of 55° to 70° to the longitudinal axis 16. The extra number of turns, e.g. >3, provides a stable attachment to the cord by distributing the force of the load over a longer distance and making it more difficult to unwind the cord from the helical hanger 12, preventing accidental release. The helical hanger 12 may range from 2 to 6 inches long depending upon the desired use, e.g. load requirement. The helical hanger 12 also facilitates lateral adjustment of the pigtail hanger 11 relative to the cord by enabling an unopposed simple sliding motion along the cord or cable.

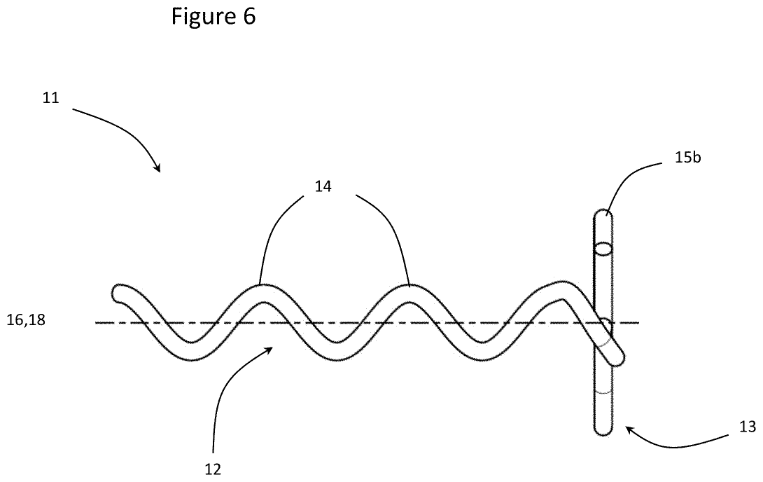

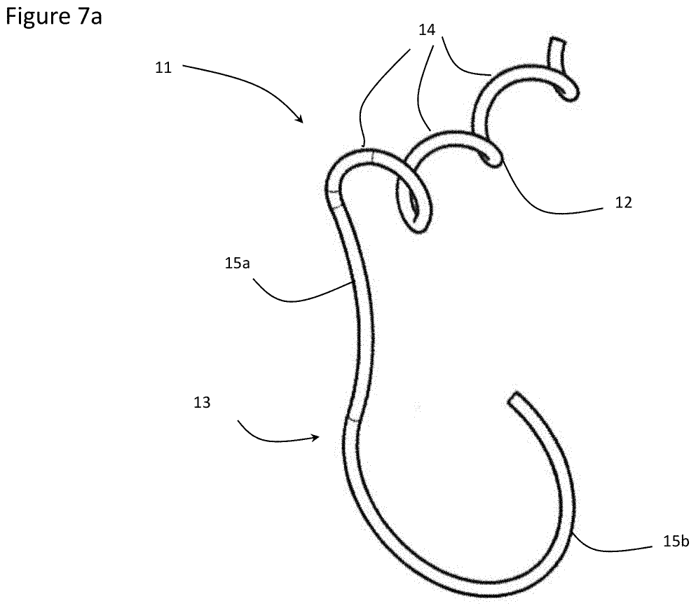

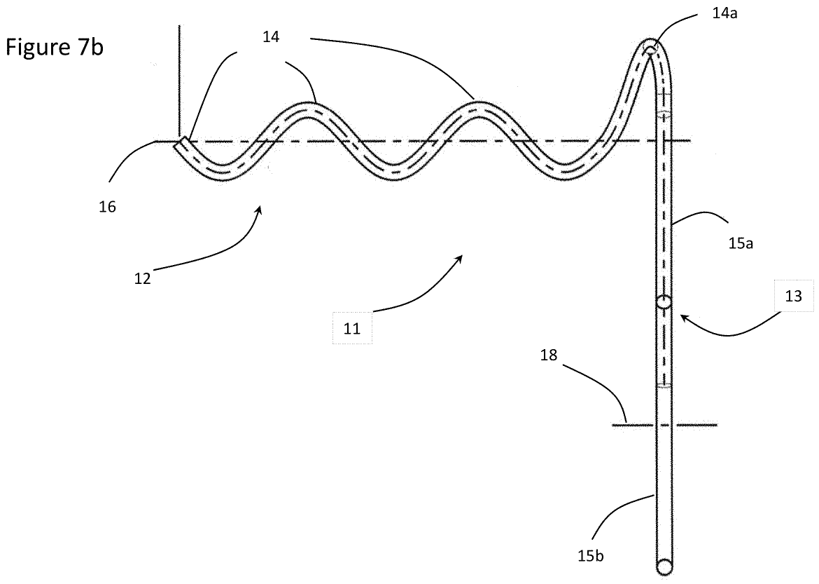

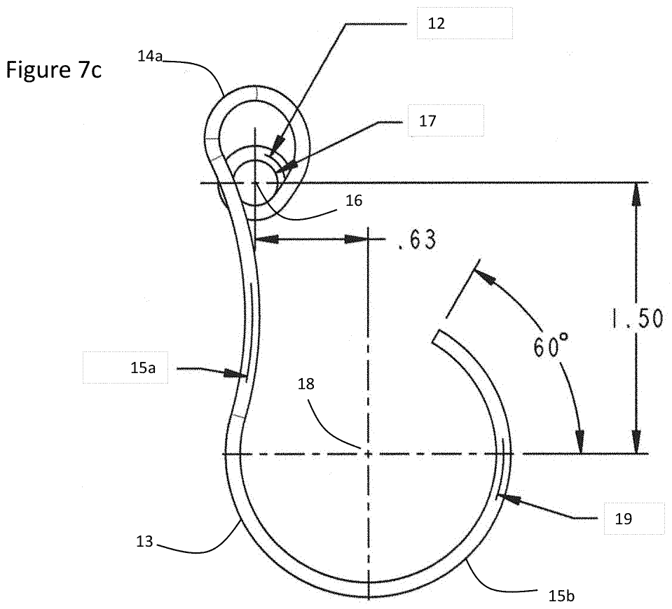

The mounting bracket 13 may be comprised of an elongated arm 15a and a hook 15b, including a central axis 18, and a radius 19, which may be any suitable length depending on the desired use, e.g. 0.5″ to 1.0″. In the illustrated embodiment, the mounting bracket 13 extends substantially perpendicular to, i.e. outwardly from the side of, the helical hanger 12. In other words, the central axis 18 of the mounting bracket 13 may be substantially parallel to the longitudinal axis 16 of the helical hanger 12, although a slight angle, e.g. 1° to 10°, between the central axis 18 and the longitudinal axis 16 may be provided, depending upon the desired usage. With reference to FIGS. 5c and 6, the central axis 18 of the hook 13 may extend directly below and in line with the longitudinal axis 16 of the spiral hanger 12, so that whatever is hanging from the hook 13 or the spiral hanger 12 is directly below the axis of whatever is supporting the hook 13 or the spiral hanger 12. With reference to FIG. 7c, the central axis 18 of the hook 13 may extend offset, and parallel to the longitudinal axis 16 of the spiral hanger 12, enabling the cord, extending through the spiral hanger 12, to be slightly laterally offset, e.g. >0.5″, from the hook 13 and therefore any surface or structure that the hook 15b is mounted on or connected to. The central axis 13 may be 1″ and 3″ from the longitudinal axis 16, but any suitable size is within the scope of the invention.

To facilitate mounting and dismounting of the helical hanger 12 onto and off of a cord or cable, the last turn 14a of the helical hanger 12 (See FIGS. 7a to 7c) may extend upwardly and outwardly from the previous turn forming a partial turn with a much larger radius than the previous turns 14, e.g. 1.5× to 3×.

Ideally, the entire pigtail hanger 11 may be comprised of a single length of resilient metallic, corrosion resistant, e.g. stainless steel, wire with a diameter of 0.05″ to 0.15″.

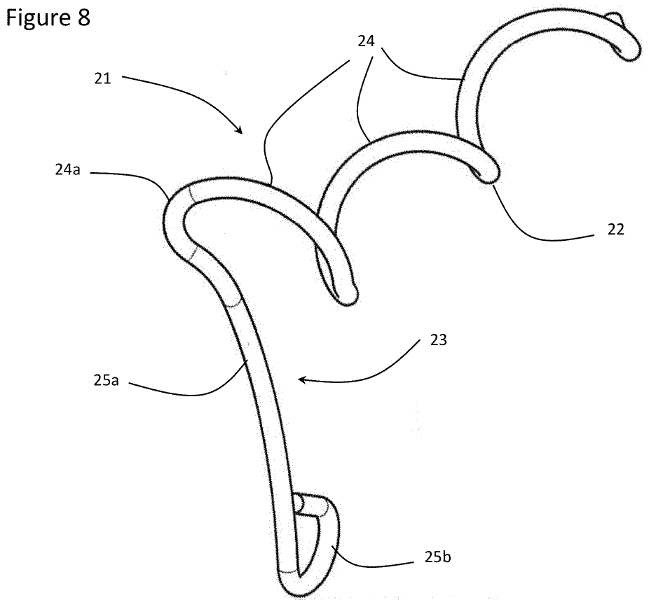

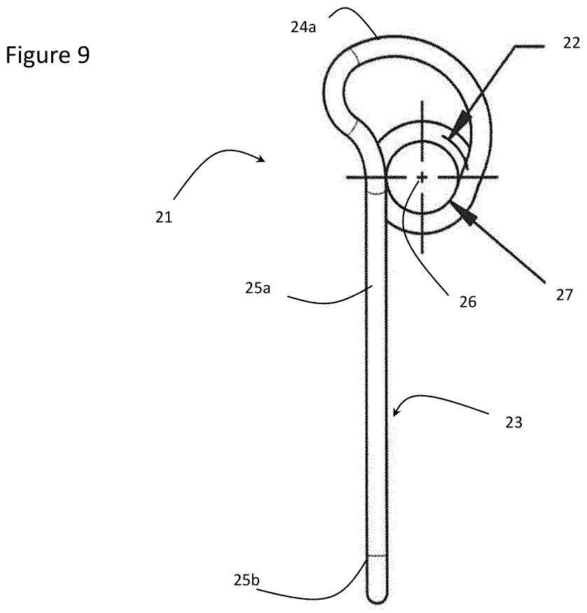

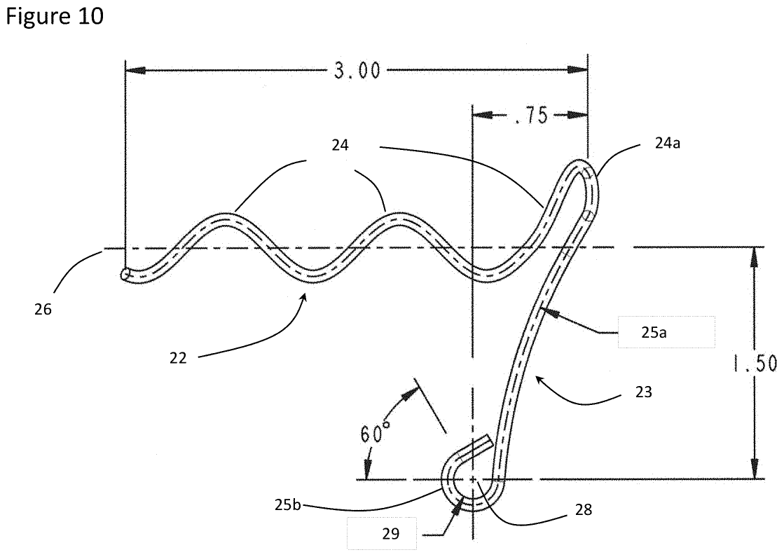

With reference to FIGS. 8 to 11, another embodiment of a pigtail hook 21 of the present invention includes a helical hanger 22 and a mounting bracket 23. The helical hanger 22 may comprise a cylindrical helix with three or more turns, preferably three to five turns 24 wound around a longitudinal axis 26, and defining a cylindrical cavity 27 with a substantial constant radius, which may be from 0.2″ to 2″. For example the cylindrical cavity 27 may comprise a radius of 0.1″ to 0.4″ for receiving a cord (not shown), such as a Christmas tree light cord or a clothes line cable. Alternatively, the cylindrical cavity 27 may comprise a radius of 0.4″ to 2″ for receiving and supporting or being supported by a larger cord or conduit, e.g. a hose. The turns 24 may have a pitch of 1.0″ to 1.5″, and may extend at an angle of 55° to 70° to the longitudinal axis 6. The extra number of turns, e.g. >3, provides a stable attachment to the cord or cable by distributing the force of the load over a longer distance and making it more difficult to unwind the cord or cable from the helical hanger 22, preventing accidental release. The helical hanger 22 may range from 2 to 6 inches long depending upon the desired use, e.g. load requirement. The helical hanger 22 also facilitates lateral adjustment of the pigtail hanger 21 relative to the cord by enabling an unopposed simple sliding motion along the cord or cable.

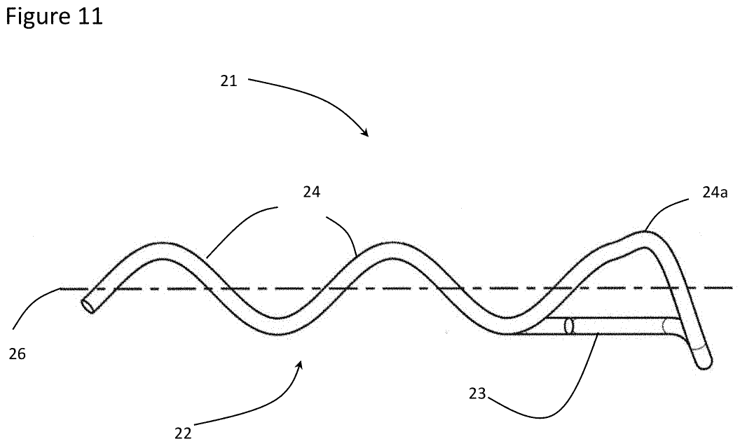

The mounting bracket 23 may comprise an elongated arm 25a extending from the last turn 24a , and a connector 25b at the outer free end of the elongated arm 25a. The connector 25b may include a central axis 28, and a radius 29, which may be any suitable length depending on the desired use, e.g. 0.1″ to 0.4″. In the illustrated embodiment, the connector 25b may be formed into a rounded and/or substantially closed shape, e.g. sized to receive the shaft of a nail or screw, but to engage the head of the nail or screw to mount the connector 25b to a wall, surface or load. As an example, the connector 25b may comprise the end of the elongated arm 25a bent back around to proximate the elongated arm 25a. In the illustrated embodiment, the mounting bracket 23 extends in substantially the same direction as the helical hanger 22, i.e. the central axis of the connector 25b is substantially perpendicular to the longitudinal axis 26 of the spiral hanger 22, although a slight angle, e.g. 1° to 10°, between the central axis 28 and the longitudinal axis 26 may be provided depending upon the desired usage. With reference to FIG. 11, the mounting bracket 23 may extend offset, and parallel to the longitudinal axis 26 of the spiral hanger 22, enabling the cord, extending through the spiral hanger 22, to be slightly offset from the top of the hook 23 and therefore any surface or structure that the mounting bracket 23 is mounted on or connected to.

To facilitate mounting and dismounting of the helical hanger 22 onto and off of a cable or cord, the last turn 24a of the helical hanger 22 may extend upwardly and outwardly from the previous turn forming a partial turn with a much larger radius than the previous turns 24, e.g. 1.5× to 3×.

Ideally, the entire pigtail hanger 21 may be comprised of a single length of resilient, metallic, corrosion resistant, e.g. stainless steel, plastic coated, wire with a diameter of 0.05″ to 0.25″.

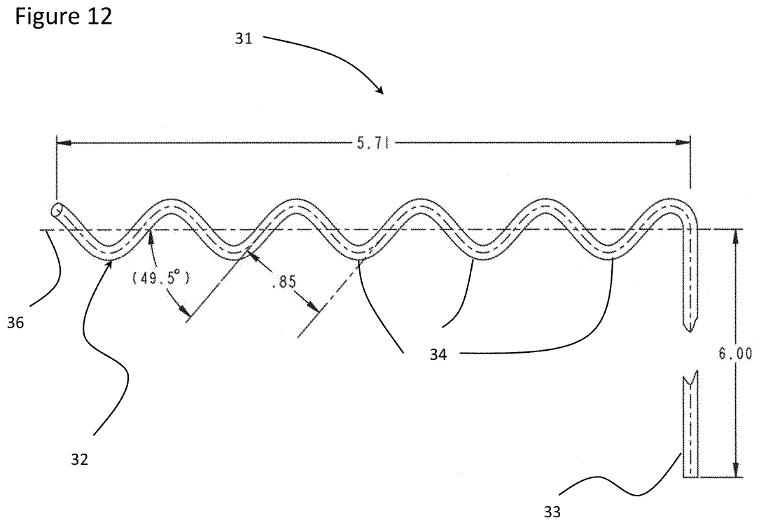

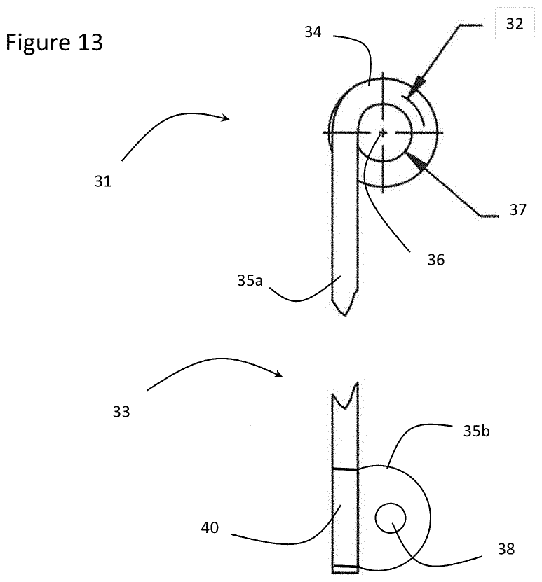

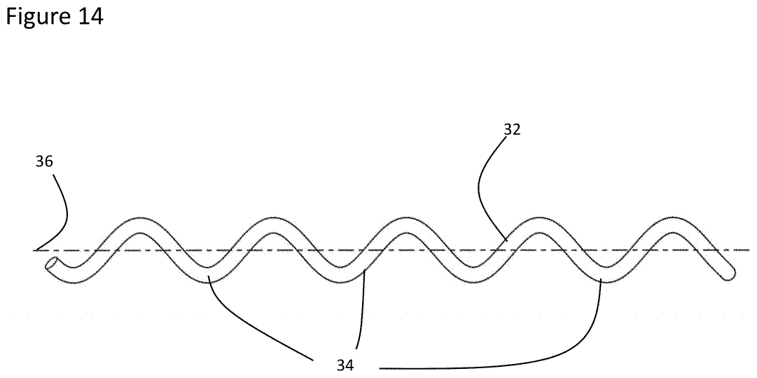

With reference to FIGS. 12 to 14, another embodiment of a pigtail hanger 31 of the present invention includes a helical hanger 32 and a mounting bracket 33. The helical hanger 32 may comprise a cylindrical helix with three or more turns, preferably three to five turns 34 wound around a longitudinal axis 36, and defining a cylindrical cavity 37 with a substantially constant radius, which may be from 0.2″ to 2″. For example the cylindrical cavity 37 may comprise a radius of 0.1″ to 0.4″ for receiving a cord (not shown), such as a Christmas tree light cord or a clothes line cable. Alternatively, the cylindrical cavity 37 may comprise a radius of 0.4″ to 2″ for receiving and supporting or being supported by a larger cord or conduit, e.g. a hose. The turns 34 may have a pitch of 0.75″ to 0.95″, and may extend at an angle of 45° to 70° to the longitudinal axis 36. The extra number of turns, e.g. >3, provides a stable attachment to the cord by distributing the force of the load over a longer distance and making it more difficult to unwind the cord or cable from the helical hanger 32, preventing accidental release. The helical hanger 32 may range from 2 to 6 inches long depending upon the desired use, e.g. load requirement. The helical hanger 32 also facilitates lateral adjustment of the pigtail hook 31 relative to the cord or cable by enabling an unopposed simple sliding motion along the cord or cable.

The mounting bracket 33 may comprise an elongated arm 35a extending from the last turn 34, and a connector 35b at the outer free end of the elongated arm 35a. The connector 35b may include a sleeve 40 surrounding the elongated arm 35a, and any form of suitable connector. In the illustrated embodiment, the connector 35b includes a planar bracket including a hole 38, which may be any suitable radius depending on the desired use, e.g. 0.1″ to 0.4″. In the illustrated embodiment, the hole 38 in the connector 35b may be sized to receive the shaft of a nail or screw, while the head of the nail or screw engages the connector 35b. In the illustrated embodiment, the mounting bracket 33 extends substantially perpendicular to the direction as the helical hanger 32, i.e. the central axis of the hole 38 is substantially parallel to the longitudinal axis 36 of the spiral hanger 32, although a slight angle, e.g. 1° to 10°, between the central axis of the hole 38 and the longitudinal axis 36 may be provided, depending upon the desired usage.

Ideally, the entire pigtail hanger 31 may be comprised of a single length of metallic, corrosion resistant, e.g. stainless steel or plastic coated, wire with a diameter of 0.05″ to 0.25″.

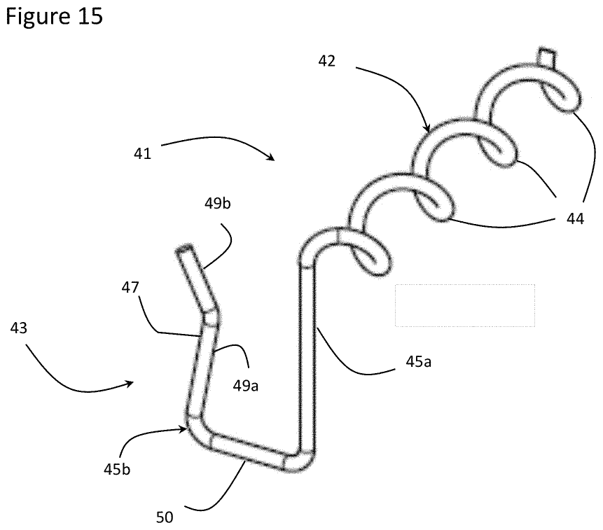

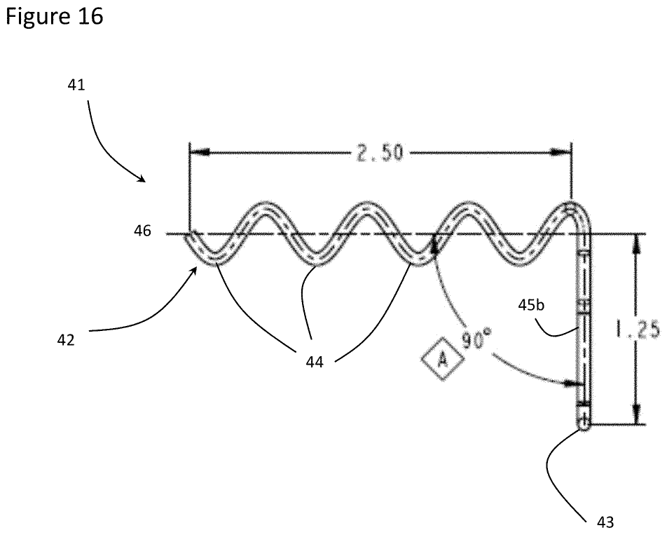

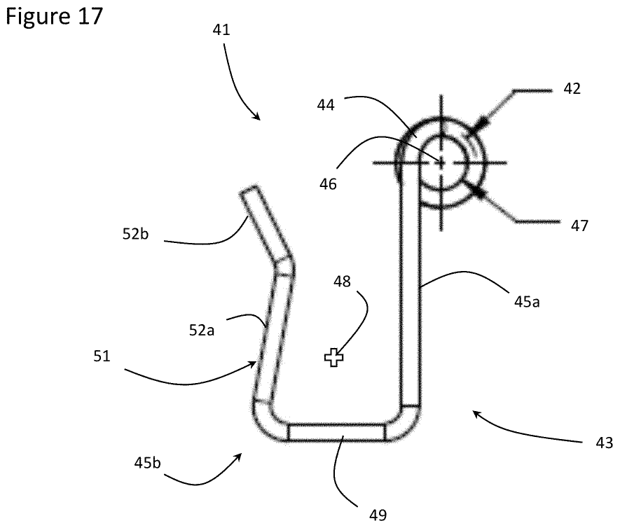

With reference to FIGS. 15 to 17, an embodiment of a pigtail hook 41 of the present invention includes a helical hanger 42 and a mounting bracket 43. The helical hanger 42 may comprise a cylindrical helix with three or more turns, preferably three to five turns 44 wound around a longitudinal axis 46, and defining a cylindrical cavity 47 with a constant radius, which may be from 0.2″ to 2″. For example the cylindrical cavity 47 may comprise a radius of 0.1″ to 0.4″ for receiving a cord (not shown), such as a Christmas tree light cord or a clothes line cable. Alternatively, the cylindrical cavity 47 may comprise a radius of 0.4″ to 2″ for receiving and supporting or being supported by a larger cord or conduit, e.g. a hose. The turns 44 may have a pitch of 1.0″ to 1.5″, and may extend at an angle of 55° to 70° to the longitudinal axis 46. The extra number of turns, e.g. >3, provides a stable attachment to the cord by distributing the force of the load over a longer distance and making it more difficult to unwind the cord from the helical hanger 42, preventing accidental release. The helical hanger 42 may range from 2″ to 6″ long depending upon the desired use, e.g. load requirement. The helical hanger 42 also facilitates lateral adjustment of the pigtail hanger 41 relative to the cord by enabling an unopposed simple sliding motion along the cord.

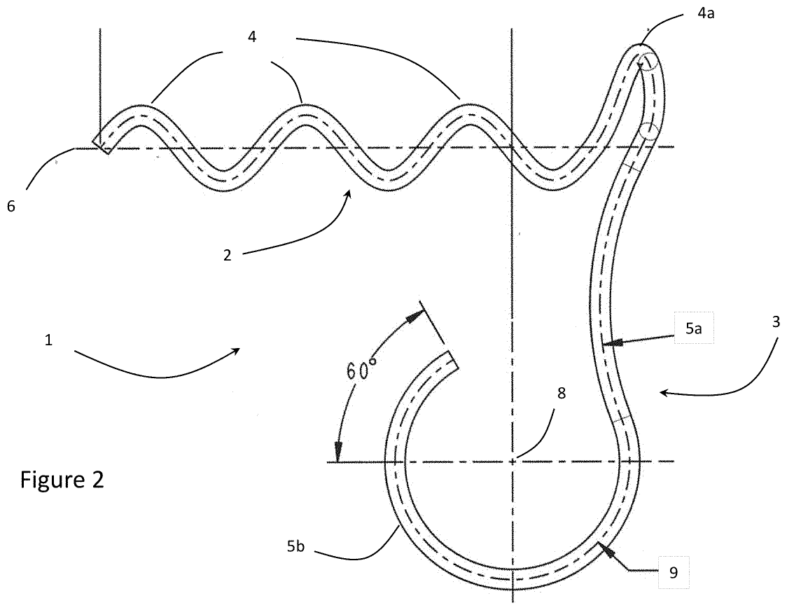

The mounting bracket 43 may be comprised of an elongated arm 45a and a hook or clip 45b, with a central axis 48, and which may be any suitable length depending on the desired use, e.g. 0.5-2.0 inches. In the illustrated embodiment, the hook 45b extends in substantially a perpendicular direction to and outwardly from the side of the helical hanger 42, i.e. the central axis 48 of the hook 45b is substantially parallel to the longitudinal axis 46 of the spiral hanger 42, although a slight angle, e.g. 1° to 10°, between the hook 45b and the longitudinal axis 46 may be provided depending upon the desired usage. Alternatively, with reference to FIGS. 2 and 4, the mounting bracket 43 may extend offset, and/or parallel to the longitudinal axis 46 of the spiral hanger 42, enabling the cord, extending through the spiral hanger 42, to be slightly offset from the top of the hook 45b and therefore any surface or structure that the hook 45b is mounted on or connected to.

The hook or clip 45b may include a base arm 49 extending substantially perpendicular to and from the elongated arm 45a, and a resilient spring arm 51 at an outer end thereof, which may be bendable away from the elongated arm 45a to enable mounting and engagement of the clip 45b onto and with an extending mounting surface, e.g. eavestrough or siding, or to enable the frictional engagement with an elongated load, e.g. hose, in the hook or clip 45b. The resilient spring arm 51 may be comprised of a first section 52a extending from the base arm 49 at an acute angle thereto towards the elongated arm 45a, and a second section 52b extending away from the elongated arm 45a, forming an engageable tab at the outer free end of the resilient spring arm 51, thereby forming an abutting surface to facilitate bending of the resilient spring arm 51 away from the elongated arm 45a either manually or by the extending mounting surface engaging the abutting surface. Accordingly, the clip 45b may be mounted and removed from a variety of different structures with relative ease without damaging the structure or the clip 45b. The joint between the first section 52a and the second section 52b, e.g. which form an obtuse angle therebetween, provides a rounded surface for engaging whatever element is received within the mounting bracket 43, thereby minimizing any damage by engagement with sharp edges.

To facilitate mounting and dismounting of the helical hanger 42 onto and off of a cable, the last turn 44 of the helical hanger 42 may extend upwardly and outwardly from the previous turn forming a partial turn with a much larger radius than the previous turns 44, e.g. 1.5× to 3×, as in FIGS. 8 to 10.

Ideally, the entire pigtail hanger 41 may be comprised of a single length of resilient, metallic, corrosion resistant, e.g. stainless steel or plastic coated, wire or rod with a diameter of 0.05″ to 0.25″.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A pigtail hanger comprising:
a helical hanger including a plurality of turns around an longitudinal axis for receiving a cable or conduit extending therethrough; and
a mounting bracket extending from the helical hanger for supporting a load.

2. The pigtail hanger according to claim 1, wherein the plurality of turns comprises at least three turns.

3. The pigtail hanger according to claim 1, wherein the plurality of turns comprises three to five turns.

4. The pigtail hanger according to claim 1, wherein the plurality of turns define a constant radius.

5. The pigtail hanger according to claim 4, wherein the helical hanger comprises a final turn connected to the mounting bracket including a radius larger than the plurality of turns facilitating mounting and removal of the helical hanger.

6. The pigtail hanger according to claim 5, wherein the final turn includes a radius 1.5× to 3.0× the radius of the plurality of other turns.

7. The pigtail hanger according to claim 1, wherein the plurality of turns comprises a pitch of 1.0″ to 1.5″.

8. The pigtail hanger according to claim 1, wherein each turn extends at an angle of 55° to 70° to the longitudinal axis.

9. The pigtail hanger according to claim 1, wherein the mounting bracket extends substantially perpendicular to the longitudinal axis of the helical hanger, and wherein the mounter bracket also comprises a hook.

10. The pigtail hanger according to claim 9, wherein the hook includes an elongated arm and a spring arm extending towards the elongated arm.

11. The pigtail hanger according to claim 10, wherein the spring arm comprises a first section angled towards the elongated arm, and a second section at the outer free end thereof extending away from the elongated arm providing a tab for engaging the spring arm and forcing the spring arm away from the elongated arm.

12. The pigtail hanger according to claim 9, wherein the hook extends substantially in the same direction as the longitudinal axis with a central axis of the hook substantially perpendicular to the longitudinal axis.

13. The pigtail hanger according to claim 12, wherein the hook extends offset from and parallel to the longitudinal axis.

14. The pigtail hanger according to claim 9, wherein the hook extends substantially perpendicular to the longitudinal axis with a central axis of the hook substantially parallel to the longitudinal axis.

15. The pigtail hanger according to claim 1, wherein the mounting bracket comprises a spring clip.

16. The pigtail hanger according to claim 1, wherein the mounting bracket comprises an elongated arm and a connector.

17. The pigtail hanger according to claim 16, wherein the connector comprises a structure for engaging a head of an elongated fastener, and an opening for receiving the elongated fastener therethrough.

18. The pigtail hanger according to claim 1, wherein the helical hanger and the mounting bracket are comprised of a single length of metallic wire.

19. The pigtail hanger according to claim 18, wherein the metallic wire includes a diameter of 0.05″ to 0.25″.

20. The pigtail hanger according to claim 1, wherein the helical hanger comprises a length of 2″ to 6″.
